(19) United States
(12) Patent Application Publication
(10) Pub. No.: US 2004/0114857 A1
(43) Pub. Date: Jun. 17, 2004

(54) Tunable pulse width generation of return-to-zero format for system optimization

(76) Inventors: Lianshan Yan, Los Angeles, CA (US); Reza Motaghian Nezam, Los Angeles, CA (US); Alan E. Willner, Los Angeles, CA (US)

Correspondence Address: Jerry L. Mahurin, FULBRIGHT & JAWORSKI L.L.P., Suite 2800, 2200 Ross Avenue, Dallas, TX, 75201-2784, US

(21) Appl. No.: 10/392,272

(22) Filed: Mar. 19, 2003

Related U.S. Application Data
(60) Provisional application No. 60/367,040, filed on Mar. 21, 2002.

(51) Int. Cl. G02B 6/26; G02B 6/34

(52) U.S. Cl. 385/27; 385/37

(57) ABSTRACT

A method for tunable optical pulse width generation comprises varying chirp of the signal of the pulse and concurrently varying dispersion of the signal. A system for tunable pulse width generation comprises a phase modulator providing the chirp modulation by modulating peak to peak phase of an optical signal and a tunable dispersion element providing the chromatic dispersion to the optical signal. A system for tunable pulse width return to zero optical signal transmission comprises at least one optical signal, a plurality of amplitude modulators for modulating the signal and a tunable pulse width generator comprising a phase modulator providing the chirp modulation and a tunable dispersion element providing the dispersion.

### CROSS-REFERENCE TO RELATED APPLICATIONS

This application claims the benefit of and priority to Provisional U.S. Patent Application Serial No. 60/367,040, filed Mar. 21, 2003, entitled TUNABLE PULSE WIDTH GENERATION OF RETURN-TO-ZERO FORMAT FOR SYSTEM OPTIMIZATION, the disclosure of which is hereby incorporated herein by reference.

### TECHNICAL FIELD

The present invention is broadly related to fiber optic communications and specifically to systems and methods for providing tunable pulse width generation of return-to-zero format for system optimization.

### BACKGROUND OF THE INVENTION

For 10-Gb/s and greater wavelength division multiplexed (WDM) transmission systems, channels experience a confluence of channel-degrading effects that relate to dispersion and nonlinearity. For example, dispersion can cause pulse broadening because different frequency components of a disperses optical signal will transmit at different speed. Also, there are a variety of nonlinear effects in optical fiber, including but not limited to self-phase-modulation (SPM), cross-phase-modulation (XPM), and four-wave-mixing (FWM). These various nonlinearities have various physical background causes. Typically, these nonlinearities can cause signal degradation in either single channel or WDM systems. Previous prior art attempts to solve these degrading effects typically only consider either dispersion or nonlinearities, primarily focusing on dispersion. The prior art fails to provide a method dealing with the combined effects of these degrading factors.

Resultantly, prior art higher-speed, longer-distance, or high spectral efficiency systems must be designed very carefully such that the data integrity will remain high at the receiver. Rigorous standards are required for deployment such that extensive fiber-link measurements are required before system design; equipment must be manufactured to exact values to account for various deleterious fiber effects; and the fiber plant cannot change after system deployment for fear of a system outage. Moreover, any system upgrades require the replacement of much of the existing terminal equipment since management of the fiber effects will change significantly. All these factors incur large operational costs for systems providers as well as severe constraints on the network operators.

### BRIEF SUMMARY OF THE INVENTION

The present invention is directed to a systems and methods which provide tunability in data pulse width for return-to-zero (RZ) formatted signals launched into an optical system. The present systems and methods may be used to address the combined effects of degrading factors such as dispersion and nonlinearities. To date, although some experimental results show the performance of different relative pulse widths. See, G. C. Gupta et al., OFC 2000, paper TuJ7; and A. Sano et al., JLT, vol. 16, pp. 977-985, 1998; the disclosures of which are incorporated herein by reference. No demonstration has shown practical tunable pulse-width management. The present systems and methods enable tunability and flexibility in terminal fiber optic equipment to enable proper system performance even under conditions that may vary over time. Another valuable feature of the present invention is that it provides pulse-width management for several WDM channels simultaneously.

The present invention provides heretofore undemonstrated generation of tunable pulse width for RZ signal transmissions. Embodiments of the present invention provide tunable pulse width management using a phase modulator and a tunable dispersion element. The only tunable pulse width generation system previously known in the art uses electro-absorption modulation. The present systems and methods are more straightforward and stable.

Typically, phase modulator, without dispersion compensation has been used to generate CRZ pulses. CRZ signals are discussed in J. -X Cai et al., ECOC 2000, paper PD 1.6, the disclosure of which is incorporated herein by reference. Such CRZ signals can be transformed into a RZ signals following dispersion management. Advantageously, the present invention may be used to alter a RZ transmission system to generate Chirped RZ (CRZ) pulses which converge to a dispersion managed soliton format. Soliton format signals are discussed in R. -M. Mu et al., JLT, 2002, the disclosure of which is incorporated herein by reference.

When compared to mode-locked lasers commonly used to create short pulses, the stability and tunability of the present systems and methods can enhance the system robustness and increase a system's power margin for both single channel and WDM systems. At higher data rates such as greater than 40 Gb/s, dynamic pulse compression down to several picoseconds is obtainable, particularly if half-wave voltage of phase modulators can be further reduced, to ensure high spectral efficiency and high capacity transmission. In other words, as long as the driving voltage limit of current phase modulator can be reduced larger chirp values can be obtained and combined with an appropriate tuned dispersion to compress the signal more, through pulse compression.

Applications for the present invention include, by way of example, high bit-rate digital fiber transmission systems, reconfigurable optical networks, and transmission of analog radio-frequency and millimeter-wave signal over fiber. The present invention is well adapted for use with RZ modulation in both WDM systems and single channel systems. All the components used by the present systems and methods are readily and commercially available for existing systems. Therefore, the present systems and methods are readily applicable to RZ transmission systems, whether single-channel or WDM systems.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a diagrammatic illustration of an embodiment of a tunable pulse width generator in accordance with the present invention, shown with a testbed loop;

FIG. 2 is a diagrammatic illustration of a system embodiment for tunable pulse width transmission in accordance with the present invention.

FIG. 3 is a graph of the interaction of chirp and dispersion at various pulse lengths;

FIG. 4 is a graph of measured power penalties for pulse widths at various residual power dispersion values;

FIG. 5 is a graph of achievable transmission distances in accordance with the present invention for pulse widths at various residual power dispersion values;

FIG. 6 is a graph of power penalties over transmission distances for various pulse widths with a 0.4 ps/nm/km residual power dispersion value;

FIG. 6 is a graph of power penalties over transmission distances for various pulse widths with a 0.8 ps/nm/km residual power dispersion value; and

FIG. 7 is a graph of power penalties over transmission distances for various pulse widths with a −0.2 ps/nm/km residual power dispersion value.

### DETAILED DESCRIPTION OF THE INVENTION

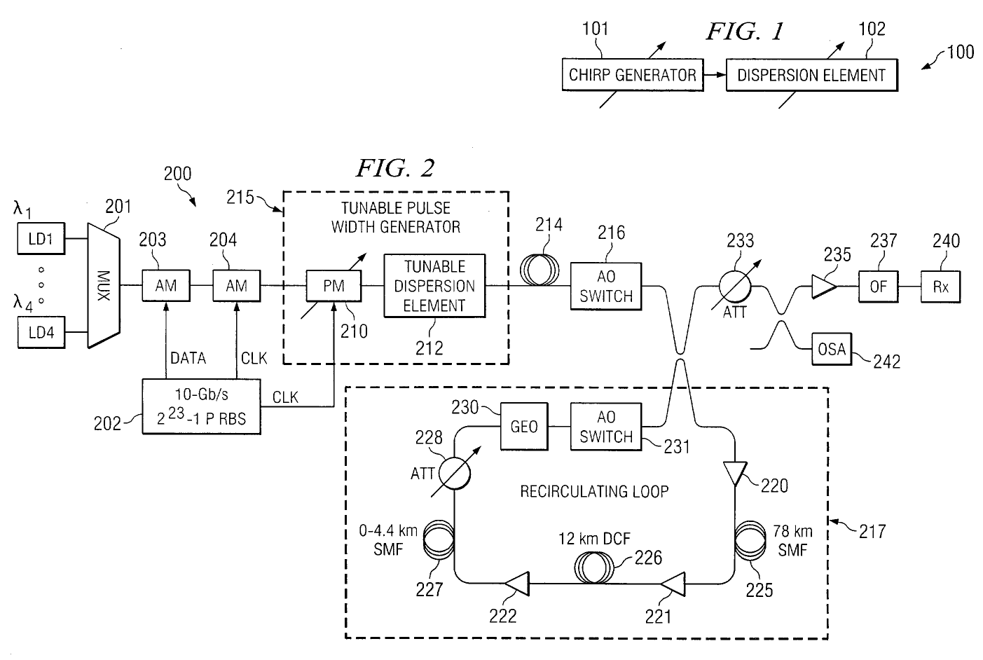

An embodiment of method 100 for tunable pulse width generation is shown in FIG. 1. Taking advantage of interaction between chirp and dispersion, a pulse can be either compressed or broadened depending on the values of chirp and dispersion. Chirp may be defined as peak to peak phase change. FIG. 1 shows tunable pulse width generation 100 by interaction of chirp generator 101 and chromatic dispersion provided by dispersion element 102. Both chirp (amplitude) and dispersion value are preferably tunable in order to provide tunable pulse width generation. In accordance with the present systems and methods, when both chirp and dispersion are tunable, the generation of RZ formatted data is insured. Otherwise, the generated signal may be chirped RZ data, which will decrease spectral efficiency.

An embodiment of system 200 for tunable pulse width RZ transmission is shown in FIG. 2. In the illustrated example four WDM channels λ₁, λ₂, λ₃, and λ₄ located, in this example, at 1553.4, 1554.2, 1555.0, and 1555.8 nm are multiplexed at 201 and RZ modulated using two cascaded electro-optic amplitude modulators 203 and 204. First amplitude modulator 203, of the example of FIG. 2, may be driven by a 2²³−1 (Pseudo Random Bit Sequence (PRBS), or the like, at a 10-Gb/s data rate provided by source 202. Source 202 may take the form of a commercially available pattern generator operated at 10 Gb/s to generate a NRZ signal, applied to the first modulator. In the Example of FIG. 2, an RZ signal with a 50-ps pulse width is obtained by driving second amplitude modulator 204 with a clock signal which may also be provided by source 202. Phase modulator 210, of FIG. 2, also driven by the clock of source 202, followed by a multi-channel tunable dispersion element 212 are used to generate tunable pulse widths in the manner discussed above in relation to FIG. 1. Phase modulator 210 and tunable dispersion element 212 make up tunable pulse width generator 215. Phase modulator 210 is used to provide peak to peak phase changes for the signals. Different tunable dispersion elements may be used as tunable dispersion element 212, such as, by way of example, fiber Bragg gratings disclosed in K. -M. Feng et al., PTL, vol. 11, pp. 373-375, 1999; and B. J Eggleton et al., JLT, pp. 1418-1832, 2000; the disclosures of which are incorporated herein by reference.

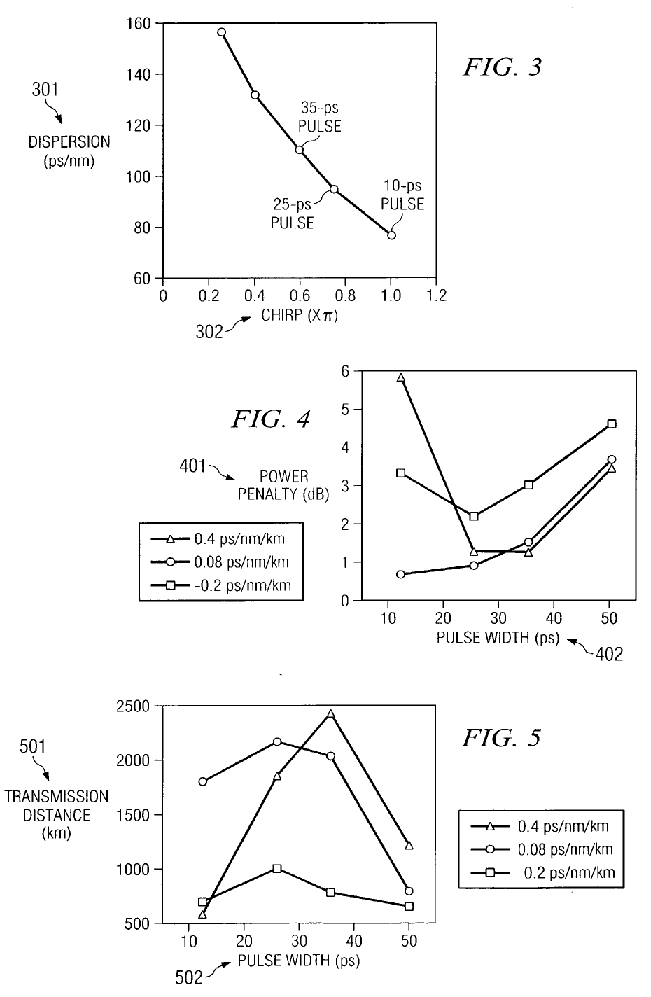

Employing the example system of FIG. 2, pulse widths ranging from 50 ps to 10 ps can typically be realized via the interaction of different amounts of chirp and dispersion as shown in FIG. 3. The amplitude of the driving signal to the phase modulator can be up to 8 Volts (V), the half-wave voltage of the modulator. Applying the data of FIG. 3 to the example of FIG. 2, ˜60 ps/nm dispersion and 8V on phase modulator 210, corresponding to a chirp value of π, generates ˜10-ps pulses. The driving voltage limit of existing phase modulators is typically about 8V. In accordance with the present invention, reduction in this driving voltage will provide larger chirp values, and when combined with dispersion as described below, will yield more compresses signal pulses. As discussed below, pulse widths of about 10 ps are obtainable using example system 200 of FIG. 2. However, if the half-wave voltage of the phase modulator decreases, pulses of only several picoseconds can be used to carry out higher data rate transmission s for 40-Gb/s or 160-Gb/s systems. A mechanically stretched, sampled, nonlinearly chirped FBG may be used as tunable dispersion element 212 to tune the dispersion from 600 to 1900 ps/nm for the four channels. Spool of single-mode fiber (SMF) 214 may be used to offset the grating to obtain a desired positive dispersion between 60 and 160 ps/nm. For single channel transmission, a different nonlinearly-chirped FGB may be used with a tuning range between 100 and 500 ps/nm with spool of SMF 214 used to offset the grating. For best performance, the group delay ripple for these example gratings is preferably ˜±10 ps.

To demonstrate the present invention recirculating loop testbed 217 may be employed. After pulse shaping, the signal may be transmitted, via Acousto-optic (AO) switch 216 through recirculating loop 217. Recirculating loop 217 may, as in the example of FIG. 2, comprise three Erbium-Doped Fiber Amplifier (EDFAs) 220, 221 and 222, 78 km of SMF 225, and 12 km of Dispersion Compensating Fiber (DCF) 226. Other spools of SMF 227 with lengths varying from 0 to 4.4 km may be used to change the residual dispersion while maintaining the Optical Signal Noise Ratio (OSNR) of the link. A long-period grating (LPG) may be used as gain equalizer 230 and to reduce the Amplified Spontaneous Emission (ASE) noise in loop 217. The signal may exit loop 217 via AO switch 231. After transmission, optical preamplifier 235 is placed before receiver 240 and Optical Filter 237 to increase the sensitivity of receiver 240. Power penalties, including the OSNR degradation, are measured by comparing the receiver sensitivity such as at a 10⁻⁹ bit-error-rate (BER) with back-to-back sensitivity (in this example −34 dBm). Further analysis of the signal may be provided by coupled-in Optical Spectrum Analyzer (OSA) 242. The results of testing using testbed 217 indicate that RZ pulse widths ranging from 50 ps to 10 ps are obtainable in the example of FIG. 2 using different combinations of chirp and dispersion. Attenuators 228 and 233 may be used to balance the optical power for the transmission or measure the transmission performance.

FIG. 4 graphs power penalties 401 after 600-km single channel transmission with varying pulse widths 402 and residual dispersion values comparing transmission performance of a single-channel for varying pulse widths. FIG. 4 shows example measured power penalties after 600 km of transmission for three different residual dispersion values, 0.4, 0.08 and −0.2 ps/nm/km. As applied to the example of FIG. 2 testbed loop 217, the optical input power provided by EDFA 220 is set to 6 dBm at 78 km of SMF 225 and at EDFA 221 the power input to DCF 226 is set to ˜−1 dBm. Three typical residual dispersion values are obtained by changing the length of small spool of SMF 227. These values, 0.4 ps/nm/km, 0.08 ps/nm/km, and −0.2 ps/nm/km, are generally equivalent to a ˜4% variation in link dispersion. For 50-ps RZ pulses, this amount of dispersion variation reduces the transmission distance at ˜5 dB power penalty from 1200 km to 600 km.

FIG. 5 graphs transmission distances 501 achieved at ˜5 dB power penalty after tuning pulse width 502 for residual dispersion values of 0.4, 0.08 and −0.2 ps/nm/km. However, this data shows that this distance can be extended to the range of 2400 km to 1000 km by using pulse widths in the 25 to 35 ps range. As indicated by FIG. 5, single channel transmissions may have an optimum range of pulse widths and pulse widths outside this range may be more sensitive to dispersion variations.

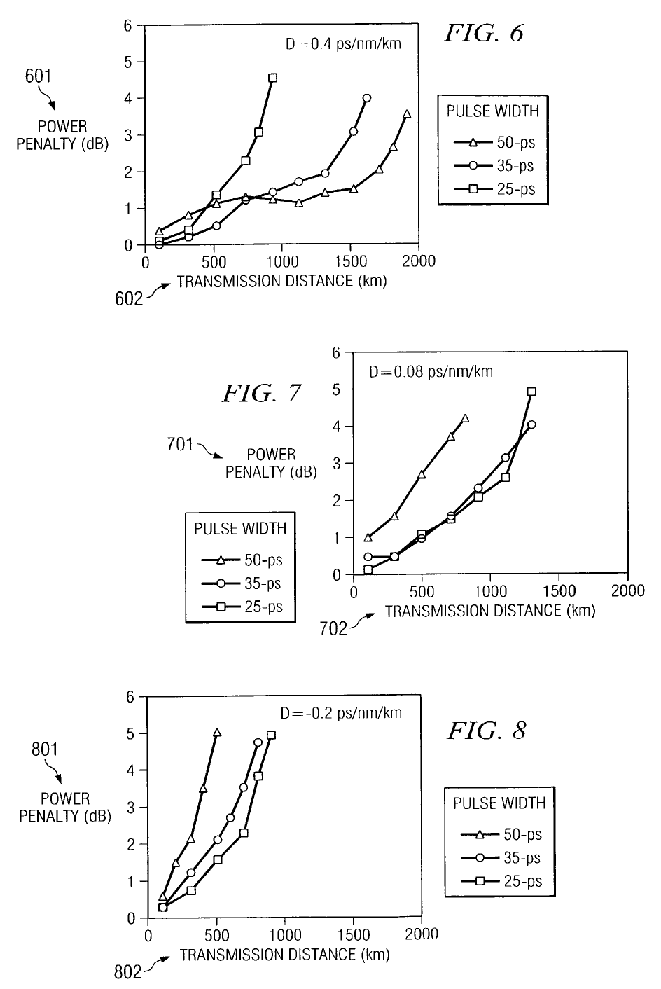

FIGS. 6 through 8 graph performance (power penalty 601, 701 and 801 versus transmission distance 602,702 and 802) of a typical channel (1555.0 nm) for different pulse widths in a four channel 10-Gb/s WDM system with 0.8 nm channel spacing under different link residual dispersion values (D). The residual dispersion values are 0.4 ps/nm/km in FIG. 6, 0.08 ps/nm/km in FIG. 7, and −0.2 ps/nm/km in FIG. 8. In FIGS. 6, 7 and 8 the solid circle data points correspond to use of a 50-ps pulse; the open circle data points correspond to use of a 35-ps pulse; and the solid square data points correspond to use of a 25-ps pulse. A sampled grating is stretched to tune the dispersion for all four channels simultaneously in the Examples graphed in FIGS. 6 through 8, consequently obtaining the same pulse width for all the channels. The channels in these examples are decorreleted after propagating through a spool of dispersive fiber. The optical power inputs for 78 km of SMF 225 and 12 km of DCF 226 are set to ˜4 dBm and −2 dBm per channel, respectively by EDFAs 220 and 221, respectively. The transmission performance of a typical channel at 1555.0 nm is measured. For the residual dispersion value of 0.4 ps/nm/km, the transmission distances achieved at 4 dB power penalty are 1900, 1600, and 800 km for pulse widths of 50, 35, and 25 ps, respectively. As the residual dispersion value approaches zero (0.08-ps/nm/kml), the distances change to 800, 1300 and 1200 km for the above listed pulse widths. Some of the curves, such as the 50-ps pulse width and 0.4 ps/nm/km curves, show the effects of fiber nonlinearities. Since nonlinearities, including both self-phase modulation (SPM) and cross-phase modulation (XPM), are key issues in WDM systems, managing pulse width at the transmitter enables flexibility in terms of system optimization.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for tunable optical pulse width generation comprising:
varying chirp of the signal of said pulse; and
varying dispersion of said signal.

2. The method of claim 1 wherein said signal is a return-to-zero formatted signal launched into an optical system.

3. The method of claim 1 wherein said signal is a wavelength division multiplexed signal.

4. The method of claim 1 wherein pulse widths of signals on several wavelength division multiplexed channels are simultaneously tuned.

5. The method of claim 1 wherein said varying chirp of said signal is carried out using a phase modulator.

6. The method of claim 5 further comprising reducing half-wave voltages of said phase modulator providing dynamic pulse compression.

7. The method of claim I wherein said varying dispersion is carried out using a tunable dispersion element.

8. The method of claim 1 further comprising:
generating chirped return to zero pulses converging to a dispersion managed soliton format.

9. A system for tunable pulse width generation comprising:
a phase modulator providing chirp modulation by modulating peak to peak phase of an optical signal; and
a tunable dispersion element providing chromatic dispersion to said optical signal.

10. The system of claim 9 wherein said tunable dispersion element is a multi-channel tunable dispersion element.

11. The system of claim 9 wherein said tunable dispersion element comprises a fiber Bragg grating.

12. The system of claim 11 wherein said fiber Bragg grating comprises a mechanically stretched, sampled, nonlinearly chirped FBG.

13. A system for tunable pulse width return to zero optical signal transmission comprising:
means for providing at least one optical signal;
a plurality of amplitude modulators for modulating said signal; and
a tunable pulse width generator comprising:
a phase modulator providing chirp modulation by modulating peak to peak phase of said optical signal; and;
a tunable dispersion element providing chromatic dispersion to said optical signal.

14. The system of claim 13 wherein said tunable dispersion element is a multi-channel tunable dispersion element.

15. The system of claim 14 wherein said tunable dispersion element comprises a fiber Bragg grating.

16. The system of claim 15 wherein said fiber Bragg grating comprises a mechanically stretched, sampled, nonlinearly chirped FBG.

17. The system of claim 13 wherein said plurality of amplitude modulators comprise:
a first amplitude modulator driven by a Pseudo Random Bit Sequence; and
a second amplitude modulator driven by a clock signal.

18. The system of claim 13 wherein said Pseudo Random Bit Sequence and said clock signal are provided by a same source.

19. The system of claim 17 wherein said tunable pulse width generator phase modulator is driven by said clock signal.

20. The system of claim 13 further comprising an optical preamplifier placed before a receiver increasing sensitivity of said receiver.
